(19) United States
(12) Patent Application Publication
(10) Pub. No.: US 2024/0243802 A1
(43) Pub. Date: Jul. 18, 2024

(54) SYSTEMS AND METHODS FOR UE-CONTROLLED SMART NODE

(71) Applicant: ZTE Corporation, Shenzhen (CN)

(72) Inventors: Shuang ZHENG, Shenzhen (CN); Nan ZHANG, Shenzhen (CN); Wei CAO, Shenzhen (CN); Ziyang LI, Shenzhen (CN)

(73) Assignee: ZTE Corporation, Shenzhen (CN)

(21) Appl. No.: 18/619,992

(22) Filed: Mar. 28, 2024

Related U.S. Application Data
(62) Division of application No. PCT/CN2022/101234, filed on Jun. 24, 2022.

(51) Int. Cl. H04B 7/155

(52) U.S. Cl. CPC H04B 7/15528; H04B 7/15557

(57) ABSTRACT

Presented are systems and methods for UE-controlled smart node. A network node may receive a first message including control information from one or a plurality of wireless communication devices.

### CROSS-REFERENCE TO RELATED APPLICATION

This application claims the benefit of priority under 35 U.S.C. § 120 as a continuation of International Patent Application No. PCT/CN2022/101234, filed on Jun. 24, 2022, the disclosure of which is incorporated herein by reference in its entirety.

### TECHNICAL FIELD

The disclosure relates generally to wireless communications, including but not limited to systems and methods for UE-controlled smart node.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A network node (e.g., a smart node) may receive a first message including control information from one or a plurality of wireless communication devices (e.g., UEs). The control information may include at least one of: a plurality of phase and amplitude information of the network node, valid timing information, on/off information of the network node, or an operation mode of the network node. The plurality of the phase and amplitude information of the network node can be indicated explicitly or implicitly. The valid timing information can be in a first format that may have a number of time units. In some embodiments, the valid timing information can be in a second format that may have a starting time and a time length. In some embodiments, the valid timing information can be in a third format that may have a starting time and an ending time. The operation mode of the network node may comprise at least one of: scatter, absorption, reflection, diffraction, or transmission.

In some embodiments, the network node may receive a second message including first authorized information before receiving the first message. The network node may receive the second message from a wireless communication node. The network node may receive the second message from an operations administration and maintenance (OAM) unit. The first authorized information may include at least one of: a sequence of identification of a plurality of wireless communication devices, a sequence of time resource grant information that corresponds to the one or the plurality wireless communication devices, a sequence of frequency resource grant information that corresponds to the one or the plurality of wireless communication devices, or priorities of the plurality of wireless communication devices. The network node may receive a fifth message including information to relieve the first authorized information from wireless communication nodes, OAM units, or the plurality of wireless communication devices.

In some embodiments, the one or the plurality of wireless communication devices may receive a third message including second authorized information before transmitting the first message to a plurality of network nodes including the network node from wireless communication nodes or an OAM unit. The second authorized information may include at least one of: a sequence of identification of the plurality of network nodes, a sequence of frequency resource information that corresponds to the plurality of network nodes, or a sequence of time resource information that corresponds to the plurality of network nodes. The wireless communication devices may receive a sixth message including information to relieve the second authorized information from wireless communication nodes or OAM units.

In some embodiments, the network node may set configuration based on the control information which may correspond to a first one of the plurality of wireless communication devices. The first wireless communication device can be an authorized wireless communication device. The first wireless communication device can be selected by the network node based on priorities of a plurality of authorized wireless communication devices. The network node may send a fourth message including feedback information to the first wireless communication device.

In some embodiments, the network node may check an authorization validity of the first wireless communication device that may have resent the control information. The network node may determine to update the control information. The network node may receive the control information from a second one of the plurality of wireless communication devices which can be different from the first wireless communication device. In response to determining whether a first priority of the first wireless communication device is lower than a second priority of the second wireless communication device, the network node may update the control information based on the first priority of the first wireless communication device and the second priority of the second wireless communication device.

In some embodiments, in response to determining that a valid time duration of the control information of the first wireless communication device has not been expired, the network node may decide not to update the control information. In response to determining that a valid time duration of the control information of the first wireless communication device has been expired, the network node may update the control information based on a priority of the second wireless communication device.

In some embodiments, a wireless communication node may broadcast existence information of the network node to the plurality of wireless communication devices. A new field can be defined in system information or a new higher layer parameter can be defined to indicate the existence information of the network node.

In some embodiments, the wireless communication devices may transmit a request of configuration information of the network node to a wireless communication node. The wireless communication devices may receive feedback information from the wireless communication node after the request of configuration information is transmitted. The wireless communication devices may receive the configuration information of the network node from the wireless communication node.

In some embodiments, one or a plurality of wireless communication devices (e.g., UEs) may send a first message including control information to a network node (e.g., a smart node).

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 is a flow diagram illustrating an interaction process with UE-controlled smart node, in accordance with an embodiment of the present disclosure.

FIG. 4 is a framework illustrating an interaction process with UE-controlled smart node, in accordance with an embodiment of the present disclosure.

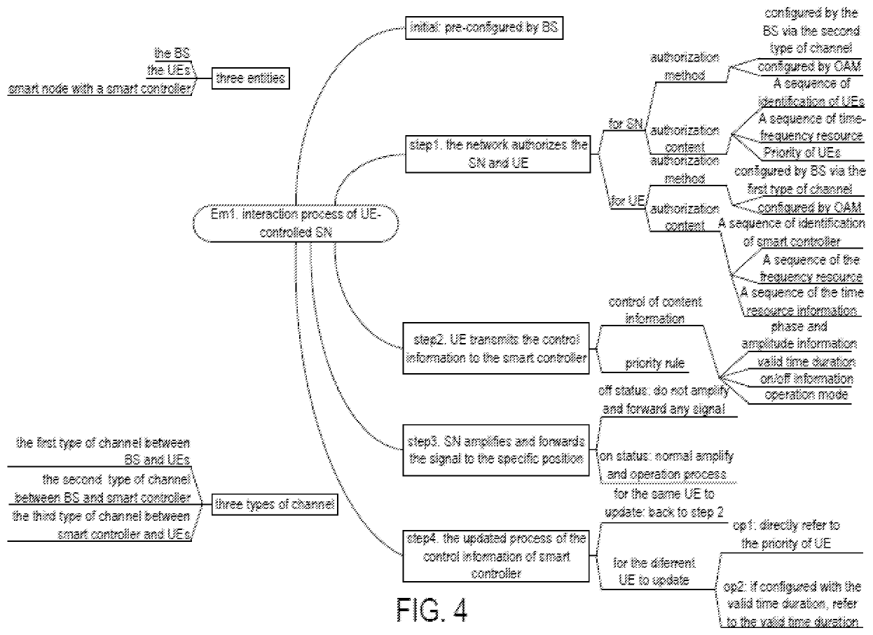

FIG. 5 is a block diagram illustrating an interaction process with UE-controlled smart node, in accordance with an embodiment of the present disclosure.

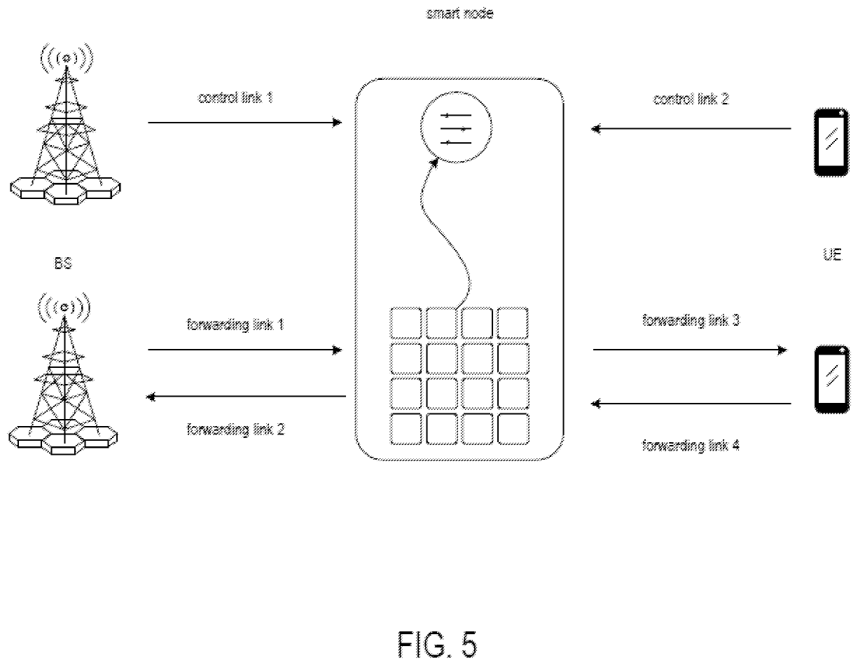

FIG. 6 illustrates a flow diagram of an example method for UE-controlled smart node, in accordance with an embodiment of the present disclosure.

### DETAILED DESCRIPTION

### 1. Mobile Communication Technology and Environment

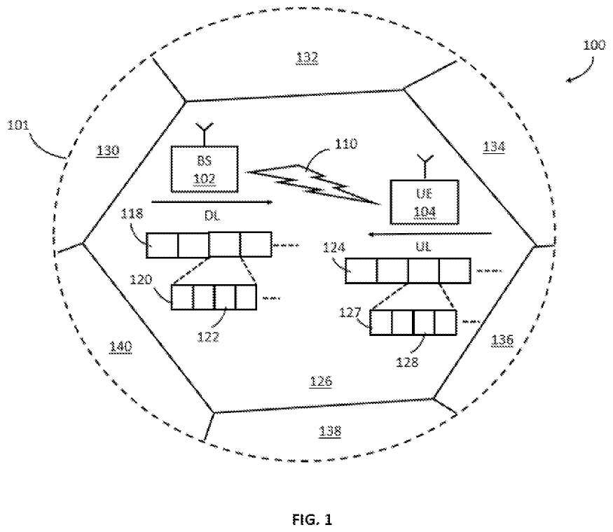

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

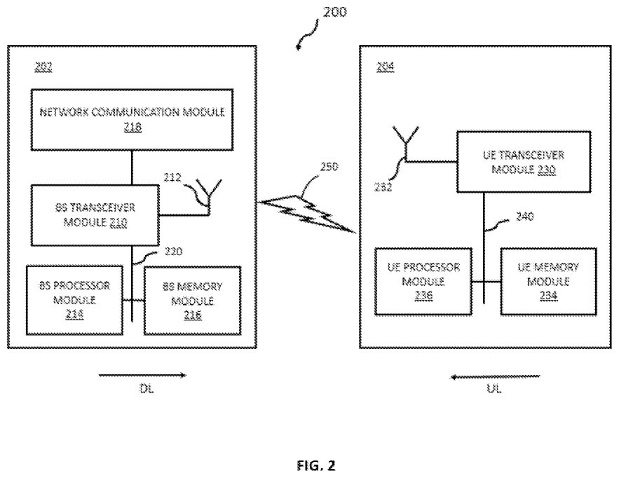

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for UE-Controlled Smart Node

RF repeaters may be used in 2G, 3G and 4G deployments to supplement a coverage provided by regular full-stack cells with various transmission power characteristics. The RF repeaters may constitute a simplest and most cost-effective way to improve network coverage. The main advantages of the RF repeaters can be low-cost, ease of deployment, and the fact that the RF repeaters may not increase latency. The main disadvantage can be that the RF repeaters may amplify signal and/or noise, which may contribute to an increase of interference (e.g., pollution) in a system. Within the RF repeaters, there can be different categories depending on power characteristics and an amount of spectrum configured to amplify (e.g., single band or multi-band). The RF repeaters can be non-regenerative type of relay nodes and may amplify-and-forward everything received. The RF repeaters can be full-duplex nodes and may not differentiate between an uplink (UL) and a downlink (DL) from transmission and/or reception standpoint. With increased traffic demands, there can be a growing interest in novel communication paradigms for future/beyond 5G wireless networks.

Reconfigurable intelligent surface (RIS) may propose as a promising new technology for reconfiguring a wireless propagation environment via software-controlled reflection. Specifically, RIS can be a planar surface comprising a large number of low-cost passive reflecting elements. Each passive reflecting element can induce an amplitude and/or phase change to an incident signal independently. RIS can be a low-cost, low-energy consuming panel. A calculation of the phase and/or the amplitude information of a huge number of passive reflecting elements can be done and can be controlled on a network side. In such case, a BS may need to collect the information from a UE and to do the corresponding calculation. The BS may send a control information to the RIS, which may increase a delay of the whole process. Therefore, other entities in the network can be considered to control the RIS.

A smart node (SN) can be generally located in a selected position with adequate wireless channel condition (e.g., with line-of-sight (LOS) path) to a BS and UEs. The smart node may comprise a planar surface and a smart controller. The planar surface may comprise a large number of low-cost passive elements. Each element can induce/make an amplitude and/or phase change to an incident signal independently. The smart controller may communicate/coordinate with other network components (e.g., BSs, UEs) through separate wireless/wired links for low-rate information exchange. The smart node can be deployed by the network. In some embodiments, the smart node can be deployed by a third party.

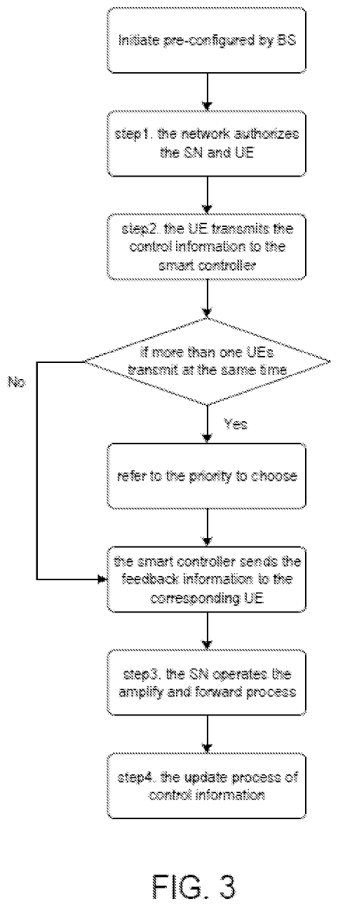

Referring now to FIG. 3, the system may include three entities: a base station (BS), one or more user equipment (UE), and a smart node (SN) with a smart controller. At least one link among the entities can be defined as follows.

Control link can be a link between the BS and the smart controller, and/or a link between the UE and the smart controller. The link between the BS and the smart controller can be called/designated as control link 1. The link between the UE and the smart controller can be called/designated as control link 2. Using the control link, the smart controller may receive control information from the BS and/or the UE.

Forwarding link can be used/utilized/applied as a link (e.g., forwarding link 1 or forwarding link 2) between the BS and the SN, and/or a link (e.g., forwarding link 3 or forwarding link 4) between the SN and the UE. When there are incident signals transmitted from the BS/UEs, the SN can forward the incident signals to a specific receiver according to configured phases and amplitudes information of each element.

### Implementation Example: An Interaction Process via a UE-Controlled Smart Node

A smart node (SN) may receive an incident signal (e.g., a first message) including control information from one or more UEs. The control information may include at least one of: a plurality of phase and amplitude information of the smart node, valid timing information, on/off information of the smart node, or an operation mode of the smart node. In order to forward the incident signal to a target, a smart controller may need to configure phase and amplitude information of each element. The network may configure control information of elements to the smart controller. In some embodiments, the BS may calculate/determine/evaluate/obtain the phase and amplitude information from received channel state information (CSI) feedback by the UE. The BS may send the control information to the smart controller. In such case, the transmitted delay of the control information can be increased, which may bring challenges in dynamic forwarding scenarios. In certain embodiments, the UE may directly transmit the control information to the smart controller of the SN. The smart controller may use/utilize the received information to configure corresponding elements.

When deploying in the network, the SN may need to be integrated into the network via the smart controller. Once the smart controller is integrated into the network, the smart controller may receive information transmitted from the BS. The initial phase and amplitude information can be pre-configured by the BS. The smart controller may receive the initial phase and amplitude information from the BS. In some embodiments, the initial phase and amplitude information can be pre-configured by an operations administration and maintenance (OAM) unit.

Following operations can be considered with the UE-controlled smart node.

Step 1.1: The UE may request information of reconfiguration intelligent surface (RIS) from the BS

When a plurality of smart nodes are deployed in the network, the BS can obtain/determine existence and configuration information of a plurality of smart nodes. The BS may broadcast the existence and configuration information of the plurality of smart nodes to served UEs. The broadcasting method can include a new field and/or a new flag. The new field can be used to indicate the existence of the plurality of smart nodes. The new field can be defined in system information. The new field can be defined in a new higher layer parameter that may be defined to indicate the existence information of the smart nodes. The new flag can be defined/used to indicate existence of the plurality of smart nodes. If the flag is configured, the UEs may know/notice the existence of the plurality of smart nodes. If the flag is not configured, the UEs may know/notice that there may not be any existence of smart nodes.

Several ways for UEs to obtain the information of smart nodes can be as follows. The BS may actively send the information of the smart nodes to specific UEs according to a communication quality of the UEs. When a UE receives the broadcast information from the BS and is notified the existence of the smart nodes, the UE may request configuration information of the smart nodes from the BS. After the BS receives the request of the UE, the BS may send feedback to the UE. The BS may send the configuration information of the smart nodes to the corresponding UEs.

Step 1.2: The network may authorize the SN and the UE

Before the UE transmits the control information to the smart controller, the UE/SN may need to be authorized by the network to allow the UE to transmit the control information. The smart node may receive a second message including first authorized information before receiving the first message. The smart node may receive the second message from a BS. In certain embodiments, the smart node may receive the second message from an operations administration and maintenance (OAM) unit. In some embodiments, the smart node may receive a fifth message including information to relieve the first authorized information from the BS, OAM units, or the UEs.

Different channels can be used to realize the communication among the three entities (e.g., the BS, the smart controller, and the UE) with following definitions. A first type of channel can be used to transmit the information between the BS and the normal UE (e.g., PDSCH). A second type of channel can be used to transmit the information between the BS and the smart controller. If the smart controller acts/behaves similar to a normal UE to communicate with the BS via a wireless link, the second type of channel can be same as the first type of channel. A third type of channel can be used to transmit the information between the UE and the smart controller.

The authorization method of the SN may include at least one of: (1) The BS may configure and transmit authorized information to the smart controller via the second type of channel. (2) The authorized information can be configured to the smart controller by an OAM. The content of the authorized information (e.g., first authorized information) may include at least one of: (i) a sequence of identification of the UEs (e.g., cell radio network temporary identifier (C-RNTI)); (ii) a sequence of time-frequency resource grant information; or (iii) priorities of the UEs. The sequence of time-frequency resource grant information may correspond to the one or more UEs (e.g., a different UE). The granted time-frequency resource can be used for the UE to transmit the control information to the smart controller. The priorities of the UEs can be used to indicate a priority when the smart controller receives more than one control information from different UEs at the same time. After the SN receives the authorized information, the smart controller may send feedback information to the BS.

In some embodiments, a UE may receive a third message including second authorized information before transmitting the first message to a plurality of network nodes including the smart node from a BS or an OAM unit. In some embodiments, the UE may receive a sixth message including information to relieve the second authorized information from the BS or the OAM units.

The authorization method of the UE may include at least one of: (1) The BS may configure and transmit authorized information to the corresponding UEs via the first type of channel. (2) The authorized information can be configured to the UEs directly by the OAM. The content of the authorized information (e.g., the second authorized information) can including at least one of: (i) a sequence of identification of the smart controller; (ii) a sequence of frequency resource information; or (iii) a sequence of time resource information. The sequence of frequency resource information may be corresponding to the plurality of smart nodes (e.g., a different smart controller). The sequence of time resource information may be corresponding to the plurality of smart nodes (e.g., a different smart controller). If a field of the sequence of time resource information is configured by the BS or the OAM, the authorized information can be only valid in a configured time duration. After the UE receives the authorized information, the UE may send feedback information to the BS. The authorization process can be finished/completed.

Step 2: The UE may transmits the control information to the smart controller

After authorized by the BS, the UE may locally calculate/determine/evaluate/obtain the phase and amplitude information according to the channel state information (CSI). The UE may transmit the control information to the smart controller via the third type of channel in the authorized frequency resource. The control information can include at least one of the following information: (i) phase and amplitude information of elements of the SN; (ii) a valid time duration; (iii) on/off information of the SN; or (iv) an operation mode of the SN. The phase and amplitude information of elements of the SN can be explicit or implicit. In some embodiments, information about the valid time duration can be optional. The valid timing information can be in a first format that may have a number of time units. The valid timing information can be in a second format that may have a starting time and a time length. The valid timing information can be in a third format that may have a starting time and an ending time. If a valid time duration is configured by the SN, the transmitted phase and amplitude information can be valid in the configured valid time duration. The operation mode of the SN may comprise at least one of: scatter, absorption, reflection, diffraction, receiving, amplifying, or transmission.

If a smart controller receives the control information from different authorized UEs at the same time, the smart controller may first check the validity of the authorization of the UEs. If there are more than one valid authorized UEs, the smart controller may select the UE with the highest priority. The smart controller may configure elements with the control information transmitted by the selected UE. After configured, the smart controller may send feedback information to the selected UE.

If the smart controller receives control information only from one authorized UE at a specific time, the smart controller can configure (e.g., set configuration) the elements of the SN according to the received control information from the UE after checking the validity of the authorized information of the UE. The smart controller may send feedback information to the UE after finishing the configuration operation of the SN.

Step 3: The SN may amplify and may forward a signal to a specific position

Once the configuration of the phase and amplitude information of the SN is finished/completed, the SN may amplify and may forward a signal to a specific position. If the SN is configured to an off status, the SN may not amplify and forward any signal. If the SN is configured to an on status, the SN may amplify and may forward an incident signal to a target area according to the configuration (e.g., element configuration).

Step 4: An update process of the control information of the smart controller

An update of the phase and amplitude information of the SN may include following cases: (1) Case 1: The same UE may reconfigure the control information of the smart controller. The smart controller may check the authorization validity of the UE. The smart controller may determine to update the control information. (2) Case 2: If a different UE transmits new control information to the smart controller, the following options can be considered. In option 1, the update process can be based on the priority. The option 1 mayindicate/mean that the smart controller may update the phase and amplitude information of element based on the priority of the UE without considering whether the valid time duration of the current control information is configured or not. For example, if a first priority of a first UE is lower that a second priority of a second UE, the smart controller may update the control information received from the first UE first. In option 2, the update process can be based on the valid time duration. If the smart controller is configured the valid time duration and the valid time duration of the current control information has not expired, the smart controller may not update the phase and element information by the newly received control information. In some embodiments, if valid time duration of the current control information of the first UE has expired, the smart controller may update the control information based on the priority of the second UE.

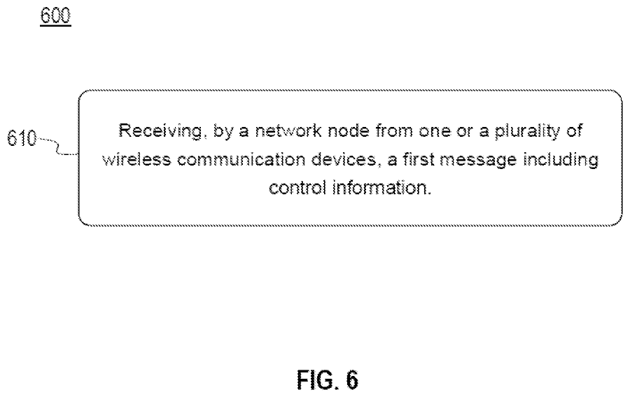

FIG. 6 illustrates a flow diagram of a method 600 for UE-controlled smart node. The method 600 may be implemented using any one or more of the components and devices detailed herein in conjunction with FIGS. 1-2. In overview, the method 600 may be performed by a network node, in some embodiments. Additional, fewer, or different operations may be performed in the method 600 depending on the embodiment. At least one aspect of the operations is directed to a system, method, apparatus, or a computer-readable medium.

A network node (e.g., a smart node) may receive a first message including control information from one or a plurality of wireless communication devices (e.g., UEs). The control information may include at least one of: a plurality of phase and amplitude information of the network node, valid timing information, on/off information of the network node, or an operation mode of the network node. The plurality of the phase and amplitude information of the network node can be indicated explicitly or implicitly. The valid timing information can be in a first format that may have a number of time units. In some embodiments, the valid timing information can be in a second format that may have a starting time and a time length. In some embodiments, the valid timing information can be in a third format that may have a starting time and an ending time. The operation mode of the network node may comprise at least one of: scatter, absorption, reflection, diffraction, receiving, amplifying, or transmission.

In some embodiments, the network node may receive a second message including first authorized information before receiving the first message. The network node may receive the second message from a wireless communication node. The network node may receive the second message from an operations administration and maintenance (OAM) unit. The first authorized information may include at least one of: a sequence of identification of a plurality of wireless communication devices, a sequence of time resource grant information that corresponds to the one or the plurality wireless communication devices, a sequence of frequency resource grant information that corresponds to the one or the plurality of wireless communication devices, or priorities of the plurality of wireless communication devices. The network node may receive a fifth message including information to relieve the first authorized information from wireless communication nodes, OAM units, or the plurality of wireless communication devices.

In some embodiments, the one or the plurality of wireless communication devices may receive a third message including second authorized information before transmitting the first message to a plurality of network nodes including the network node from wireless communication nodes or an OAM unit. The second authorized information may include at least one of: a sequence of identification of the plurality of network nodes, a sequence of frequency resource information that corresponds to the plurality of network nodes, or a sequence of time resource information that corresponds to the plurality of network nodes. The wireless communication devices may receive a sixth message including information to relieve the second authorized information from wireless communication nodes or OAM units.

In some embodiments, the network node may set configuration based on the control information which may correspond to a first one of the plurality of wireless communication devices. The first wireless communication device can be an authorized wireless communication device. The first wireless communication device can be selected by the network node based on priorities of a plurality of authorized wireless communication devices. The network node may send a fourth message including feedback information to the first wireless communication device.

In some embodiments, the network node may check an authorization validity of the first wireless communication device that may have resent the control information. The network node may determine to update the control information. The network node may receive the control information from a second one of the plurality of wireless communication devices which can be different from the first wireless communication device. In response to determining whether a first priority of the first wireless communication device is lower than a second priority of the second wireless communication device, the network node may update the control information based on the first priority of the first wireless communication device and the second priority of the second wireless communication device.

In some embodiments, in response to determining that a valid time duration of the control information of the first wireless communication device has not been expired, the network node may decide not to update the control information. In response to determining that a valid time duration of the control information of the first wireless communication device has been expired, the network node may update the control information based on a priority of the second wireless communication device.

In some embodiments, a wireless communication node may broadcast existence information of the network node to the plurality of wireless communication devices. A new field can be defined in system information or a new higher layer parameter can be defined to indicate the existence information of the network node.

In some embodiments, the wireless communication devices may transmit a request of configuration information of the network node to a wireless communication node. The wireless communication devices may receive feedback information from the wireless communication node after the request of configuration information is transmitted. The wireless communication devices may receive the configuration information of the network node from the wireless communication node.

In some embodiments, one or a plurality of wireless communication devices (e.g., UEs) may send a first message including control information to a network node (e.g., a smart node).

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements.

Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

What is claimed is:

1. A wireless communication method, comprising:
receiving, by a network node from one or a plurality of wireless communication devices, a first message including control information.

2. The wireless communication method of claim 1, wherein the control information includes at least one of: a plurality of phase and amplitude information of the network node, valid timing information, on/off information of the network node, or an operation mode of the network node.

3. The wireless communication method of claim 2, wherein the plurality of the phase and amplitude information of the network node can be indicated explicitly or implicitly.

4. The wireless communication method of claim 2, wherein the valid timing information is in a first format that has a number of time units.

5. The wireless communication method of claim 2, wherein the valid timing information is in a second format that has a starting time and a time length.

6. The wireless communication method of claim 2, wherein the valid timing information is in a third format that has a starting time and an ending time.

7. The wireless communication method of claim 2, wherein the operation mode of the network node comprises at least one of: scatter, absorption, reflection, diffraction, receiving, amplifying, or transmission.

8. The wireless communication method of claim 1, further comprising:
receiving, by the network node, a second message including first authorized information before receiving the first message.

9. The wireless communication method of claim 8, wherein the second message is received by the network node from a wireless communication node or an operations administration and maintenance (OAM) unit.

10. The wireless communication method of claim 8, wherein the first authorized information includes at least one of: a sequence of identification of a plurality of wireless communication devices, a sequence of time resource grant information that corresponds to the one or the plurality wireless communication devices, a sequence of frequency resource grant information that corresponds to the one or the plurality of wireless communication devices, or priorities of the plurality of wireless communication devices.

11. The wireless communication method of claim 1, wherein the one or the plurality of wireless communication devices receive, from wireless communication nodes or an OAM unit, a third message including second authorized information before transmitting the first message to a plurality of network nodes including the network node.

12. The wireless communication method of claim 11, wherein the second authorized information includes at least one of: a sequence of identification of the plurality of network nodes, a sequence of frequency resource information that corresponds to the plurality of network nodes, or a sequence of time resource information that corresponds to the plurality of network nodes.

13. The wireless communication method of claim 1, further comprising:
setting configuration, by the network node, based on the control information which corresponds to a first one of the plurality of wireless communication devices.

14. The wireless communication of claim 13, wherein the first wireless communication device is an authorized wireless communication device.

15. The wireless communication of claim 13, wherein the first wireless communication device is selected by the network node based on priorities of a plurality of authorized wireless communication devices.

16. The wireless communication method of claim 13, further comprising:
sending, by the network node to the first wireless communication device, a fourth message including feedback information.

17. The wireless communication method of claim 13, further comprising:
checking, by the network node, an authorization validity of the first wireless communication device that has resent the control information; and
determining, by the network node, to update the control information.

18. A wireless communication method, comprising:
sending, by one or a plurality of wireless communication devices to a network node, a first message including control information.

19. At least one wireless communication device, comprising:
at least one processor configured to:
send, via at least one transmitter to a network node, a first message including control information.

20. A network node, comprising:
at least one processor configured to:
receive, via a receiver from one or a plurality of wireless communication devices, a first message including control information.
